(19) United States
(12) Patent Application Publication
(10) Pub. No.: US 2012/0048669 A1
(43) Pub. Date: Mar. 1, 2012

(54) DRIVE MODULE OF POWER TRUNK USING MECHANICAL CLUTCH GEAR

(75) Inventors: Kwang Hoon Hong, Daegu (KR); Dae Hee Lee, Incheon (KR)

(73) Assignees: Hyundai Motor Company, Seoul (KR); PYEONG HWA AUTOMOTIVE CO., LTD., Daegu (KR); Kia Motors Corporation, Seoul (KR)

(21) Appl. No.: 12/946,730

(22) Filed: Nov. 15, 2010

(30) Foreign Application Priority Data
Aug. 31, 2010 (KR) 10-2010-0084475

(51) Int. Cl. F16H 35/00

(52) U.S. Cl. 192/21

(57) ABSTRACT

A drive module of a power trunk using a mechanical clutch gear may prevent a trunk door from being restricted by an electric motor when manually opening and closing a power trunk without using the electric motor, thereby reducing manual opening and closing force. The drive module may include a first middle gear receiving power of a motor and including a protruding portion formed on one side thereof, a second middle gear including a plurality of projections formed on an inner circumference thereof, and a stopper located inside the second middle gear, wherein the stopper comprises two supports capable of being in contact with the protruding portion such that the protruding portion presses one of the two supports to project outside the stopper according to rotational movement of the first middle gear in a clockwise or counterclockwise direction and one end of the projecting support is caught by the projection of the second middle gear to transmit a rotational force of the first middle gear to the second middle gear.

### CROSS-REFERENCE TO RELATED APPLICATION

This application claims priority of Korean Patent Application Number 10-2010-0084475 filed Aug. 31, 2010, the entire contents of which are incorporated herein for all purposes by this reference.

### BACKGROUND

1. Technical Field

The present disclosure relates to a drive module of a power trunk using a mechanical clutch gear. More particularly, it relates to a drive module of a power trunk using a mechanical clutch gear, which can prevent a trunk door from being restricted by an electric motor when manually opening and closing a power trunk without using the electric motor, thereby reducing manual opening and closing force.

2. Background Art

A power trunk is a vehicle trunk which can be automatically opened and closed by an electric motor, and its application is gradually increased due to the development of high quality vehicles with extra features.

FIG. 5 shows the configuration of a conventional drive module of a power trunk. As shown in FIG. 5, the conventional drive module of the power trunk includes a drive gear 20 connected to a motor 10 to transmit the rotational force, a driven gear 30 engaged with the drive gear 20, an arm 600 connected to the driven gear 30, and a rod 700 connected to the arm 600 and a hinge of a trunk door (not shown).

When the motor 10 rotates the drive gear 20 during automatic opening and closing operation of the power trunk, the driven gear 30 engaged with the drive gear 20 rotates, and the rotational force of the driven gear 30 is transmitted to the arm 600 connected to the driven gear 30, thereby rotating the arm 600. At this time, the rotational force of the arm 600 is transmitted to the hinge of the trunk door through the rod 700, thereby automatically opening and closing the trunk door.

Meanwhile, the power trunk may be manually opened and closed by a user without using the electric motor. However, when the user manually opens and closes the trunk door, the rotational force of the door hinge is transmitted to the arm 600 through the rod 700, and the rotational force of the arm 600 rotates the driven gear 20 connected thereto, the drive gear 20, and the motor 10 at the same time. That is, since the motor 10, the gears 20 and 30, the arm 600, the rod 700, and the door hinge of the power trunk are connected together, they move together during manual opening and closing of the power trunk as well as during automatic opening and closing.

Therefore, in the case of the above-described conventional drive module of the power trunk, a lot of force is required to manually open and close the trunk door. That is, since the power trunk door has a structure in which the motor 10 rotates together with the rotation of the door hinge, unlike the typical trunk door, the trunk door is restricted by the motor 10 during manual opening and closing of the trunk door, and thus it requires a lot of force compared to the typical trunk door.

Therefore, a new drive module capable of reducing the manual opening and closing force is required to solve the problems associated with the conventional drive module of the power trunk.

The information disclosed in this Background section is only for enhancement of understanding of the general background of the invention and should not be taken as an acknowledgement or any form of suggestion that this information forms the prior art already known to a person skilled in the art.

### SUMMARY OF THE DISCLOSURE

The present invention has been made in an effort to solve the above-described problems associated with prior art. Accordingly, the present invention provides a drive module of a power trunk, which can reduce an opening and closing force when manually opening and closing the power trunk without using a driving force of an electric motor, thereby allowing a user to open and close a trunk door with a small force.

In one aspect, the present invention provides a drive module of a power trunk using a mechanical clutch gear, the drive module including a first middle gear receiving power of a motor and including a protruding portion formed on one side thereof, a second middle gear including a plurality of projections formed on an inner circumference thereof, and a stopper located inside the second middle gear, wherein the stopper comprises two supports capable of being in contact with the protruding portion such that the protruding portion presses one of the two supports to project outside the stopper according to rotational movement of the first middle gear in a clockwise or counterclockwise direction and one end of the projecting support is caught by the projection of the second middle gear to transmit a rotational force of the first middle gear to the second middle gear.

The two supports may be configured to vertically penetrate both ends of the stopper, which are in contact with the protruding portion.

Each of the supports may further include an elastic member such that, when the protruding portion presses the support in the rotational direction, one end of the support projects outside the stopper, whereas, when the protruding portion does not press the support, the one end of the support does not project outside the stopper by an elastic force of the elastic member.

The protruding portion may be formed into an arc shape.

The drive module may further include an arm for transmitting and receiving a rotational force to and from the second middle gear, and a rod connected to the arm and a door hinge of the power trunk to transmit and receive an opening and closing force of the power trunk.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a diagram showing the configuration of an exemplary drive module of a power trunk in accordance with the present invention.

FIGS. 2(a) and 2(b) are a perspective view and a cross-sectional view, respectively, showing an exemplary connection relation between a first middle gear, a second middle gear, and a stopper in accordance with the present invention.

FIGS. 3(a), 3(b), 3(c), 3(d) and 3(e) are a diagram showing an operation in which an exemplary power trunk is automatically opened and closed in accordance with the present invention.

FIGS. 4(a), 4(b), 4(c) and 4(d) are a diagram showing an operation in which an exemplary power trunk is manually opened and closed in accordance with the present invention.

FIG. 5 is a diagram showing the configuration of a conventional drive module of a power trunk.

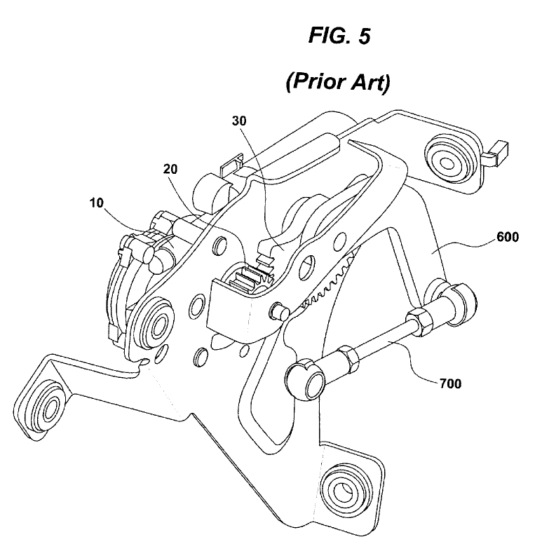

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

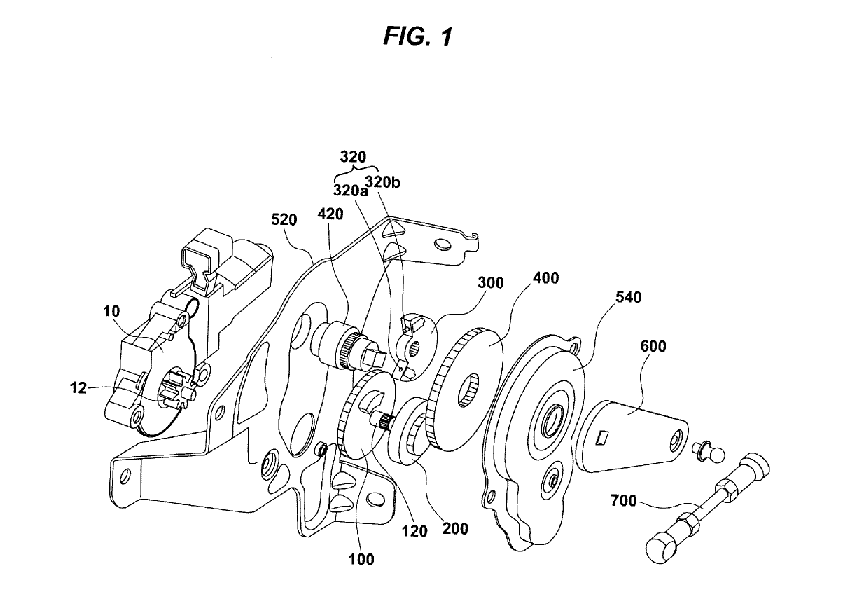

FIG. 1 shows the configuration of a drive module of a power trunk in accordance with various embodiments of the present invention. The drive module may include a motor 10, a pinion gear 12, a first middle gear 100, a second middle gear 200, a stopper 300, a main gear 400, an arm 600, and a rod 700. Here, the pinion gear 12, the first middle gear 100, the second middle gear 200, the stopper 300, and the main gear 400 may be located inside a base plate 520 and a cover plate 540.

The pinion gear 12 may be directly connected to the motor 10 to transmit the power of the motor 10. The first middle gear 100 may be engaged with the pinion gear 12 to receive the power of the motor 10 and may include a protruding portion 120 formed on one side thereof. One surface of the first middle gear 100 is in contact with the second middle gear 200, and preferably the protruding portion 120 of the first middle gear 100 may be formed on the surface which is in contact with the second middle gear 200.

The stopper 300 is located inside the second middle gear 200 and includes two supports 320a and 320b capable of being in contact with the protruding portion 120 of the first middle gear 100. In the present invention, the supports 320a and 320b may be configured to be in contact with both sides in the circumferential direction of the protruding portion 120, respectively. Therefore, when the first middle gear 100 rotates in a clockwise or counterclockwise direction, the one side of the protruding portion 120 may be in contact with any one of the two supports 320a and 320b.

Meanwhile, the second middle gear 200 may be engaged with the main gear 400 to transmit and receive the rotational force to and from the arm 600 through an arm shaft 420 connected to the main gear 400. The arm 600 may be connected to a hinge of a trunk door (not shown) through the rod 700 to transmit and receive the rotational force to and from the door hinge.

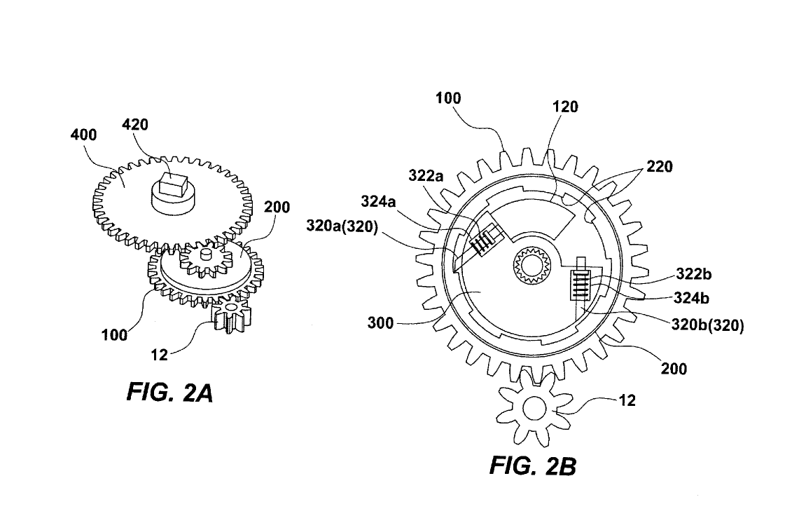

FIG. 2 shows a connection relation between the first middle gear 100, the second middle gear 200, and the stopper 300 in accordance with various embodiments of the present invention. As shown in FIG. 2, the drive module of the power trunk according to the present invention may include the first middle gear 100, the second middle gear 200, and the stopper 300.

One surface of the first middle gear 100 and that of the second middle gear 200 may be in contact with each other, and the first middle gear 100 may include the protruding portion 120 formed on one side thereof to be in contact with the second middle gear 200. Preferably, the protruding portion 120 may be formed into an arc shape, and both sides in the circumferential direction of the protruding portion 120 may be in contact with any one of the two supports 320a and 320b formed on the stopper 300, respectively.

In various embodiments of the present invention, the stopper 300 may be located inside the second middle gear 200 and formed into an arc shape. The cross-sectional view of FIG. 2 shows the state where the protruding portion 120 and the stopper 300 are in contact with each other inside the second middle gear 200.

The stopper 300 may be disposed on the same circumference as the protruding portion 120 of the first middle gear 100, and preferably an appropriate gap may be formed between the stopper 300 and the protruding portion 120 in the circumferential direction. Therefore, as will be described later, in the case where the rotational force of the motor 10 is not transmitted to the first middle gear 100, the protruding portion 120 is separated from the stopper 300 and does not press the stopper 300 and the support 320 formed on the stopper 300 in the circumferential direction.

In the present invention, the supports 320a and 320b formed on the stopper 300 may be configured to be in contact with the both sides in the circumferential direction of the protruding portion 120, respectively. Therefore, when the first middle gear 100 rotates in a clockwise or counterclockwise direction, the protruding portion 120 may be in contact with any one of the two supports 320a and 320b in the circumferential direction to press the selected support, and the pressed support may protrude outside the stopper 300.

In various embodiments of the present invention, the supports 320a and 320b formed on the stopper 300 may be configured to penetrate both ends of the stopper 300 which are in contact with the protruding portion 120. More preferably, the supports 320a and 320b may be configured to vertically penetrate the both ends of the stopper 300 and protrude outside the stopper 300. Therefore, if the protruding portion 120 presses the supports 320a and 320b, the supports 320a and 320b may move inside the stopper 300 in the pressing direction of the protruding portion 120.

Here, the supports 320a and 320b may have a length greater than that of a through hole (not shown) formed such that the support 320 penetrates therethrough. Therefore, the supports 320a and 320b may protrude to at least one of the contact surface between the stopper 300 and the protruding portion 120 and the outside of the stopper 300.

According to various embodiments of the present invention, the supports 320a and 320b may include elastic members 322a and 322b, respectively. The elastic members 322a and 322b may be placed in grooves 324a and 324b formed inside the stopper 300 to push the supports 320a and 320b toward the contact surface of the protruding portion 120 with their elasticity.

Therefore, when the supports 320a and 320b are not pressed by the protruding portion 120 in the circumferential direction, the supports 320a and 320b do not protrude outside the stopper 300 by the elastic force exerted by the elastic members 322a and 322b. Moreover, preferably, since the supports 320a and 320b have a length greater than that of the through hole formed in the stopper 300, the supports 320a and 320b may protrude only to the contact surface of the protruding portion 120.

Meanwhile, when the first middle gear 100 receives the power of the motor 10 and rotates in a clockwise or counterclockwise direction, any one of the supports 320a and 320b is in contact with the protruding portion 120 formed on the first middle gear 100 in the rotational direction.

In detail, FIG. 2 shows the state where the first middle gear 100 rotates in a counterclockwise direction. When the first middle gear 100 rotates in the counterclockwise direction, the protruding portion 120 presses the support 320a, and the pressed supports 320a overcomes the elastic force of the elastic member 322a and protrudes outside the stopper 300.

In various embodiments of the present invention, the second middle gear 200 located outside the stopper 300 may include a plurality of projections 220 formed on the inner circumference thereof. Therefore, as the projections 220 project to the outside of the stopper 300, one end of the protruding support 320a is caught by the projection 220 formed inside the second middle gear 200.

When the one end of the support 320a is caught by the projection 220, the rotational force of the first middle gear 100 is transmitted to the second middle gear 200 through the protruding portion 120 and the support 320a, thereby rotating the second middle gear 200. That is, the rotational power of the motor 10 can be transmitted to the second middle gear 200 through the first middle gear 100.

As such, the support 320 formed on the stopper 300 according to the present invention projects outside the stopper 300 only when the first middle gear 100 is rotated by the motor 10, thereby transmitting the rotational force to the second middle gear 200. Meanwhile, when the first middle gear 100 is not rotated by the motor 10 and the second middle gear 200 is first rotated, the protruding portion 120 does not press the supports 320a and 320b, and thus only the second middle gear 200 can rotate in a state where the support 320a and 320b do not project outside the stopper 300.

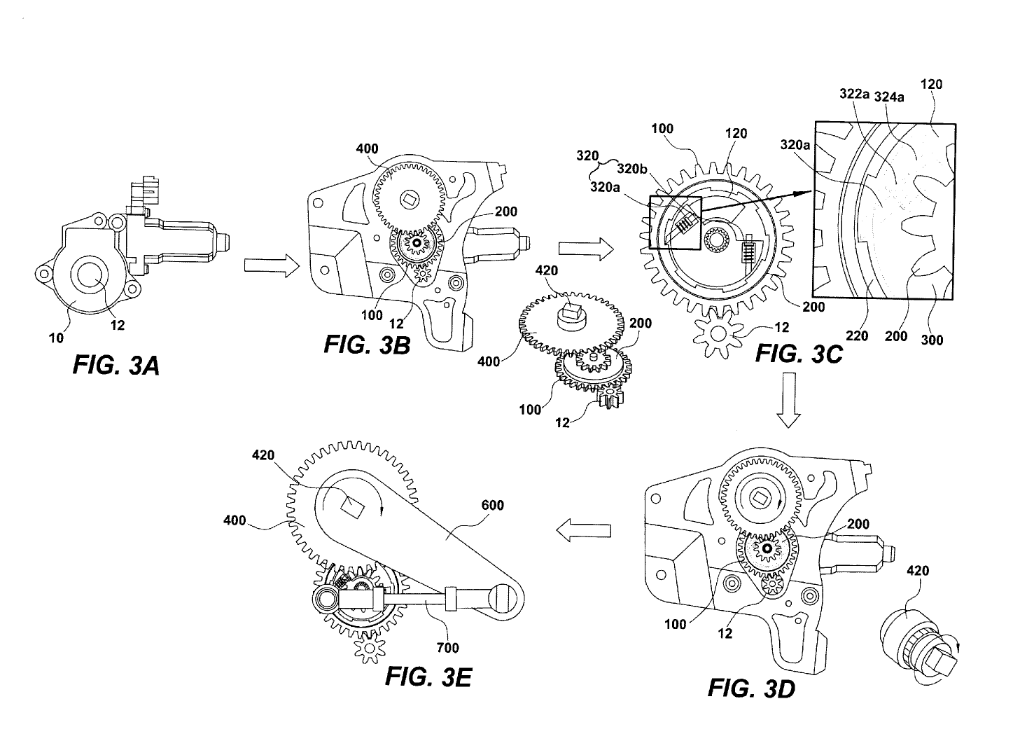

FIG. 3 shows an operation in which the power trunk is automatically opened and closed in accordance with various embodiments of the present invention.

First, when the power trunk door is automatically opened and closed by power in the present invention, the motor 10 can rotate in a clockwise or counterclockwise direction according to the opening and closing of the door. FIG. 2 shows the state where the motor 10 rotates in a counterclockwise direction and thus the trunk door is automatically opened.

When the motor 10 rotates in a counterclockwise direction, the pinion gear 12 connected to the motor 10 rotates in a clockwise direction as shown in (a) of FIG. 3. When the pinion gear 12 rotates in the clockwise direction, the first middle gear 100 directly engaged with the pinion gear 12 rotates in a counterclockwise direction as shown (b) in FIG. 3.

When the first middle gear 100 rotates in the counterclockwise direction, the protruding portion 120 formed on one side of the first middle gear 100 rotates in the counterclockwise direction and then is in contact with one side of the stopper 300 located on the same circumference. Here, the protruding portion 120 presses the support 320a formed on the stopper 300, and thus the pressed support 320a overcomes the elastic force of the elastic member 322a to project outside the stopper 300 as shown in (c) of FIG. 3.

The support 320a projecting outside the stopper 300 is caught by the projection 220 formed on the second middle gear 200 located outside the stopper 300, and the support 320a transmits the rotational force of the protruding portion 120 to the projection 220 to rotate the second middle gear 200 in the counterclockwise direction as shown in (c) of FIG. 3. As a result, the rotational force of the motor 10 can be transmitted to the second middle gear 200 through the first middle gear 100.

Meanwhile, as the second middle gear 200 rotates in the counterclockwise direction, the main gear 400 engaged with the second middle gear 200 can be rotated in the clockwise direction as shown in (d) of FIG. 3. As the main gear 400 rotates in the clockwise direction, the arm shaft 420 connected to the main gear 400 and the arm 600 transmits the rotation of the main gear 400 to the arm 600, thereby rotating the arm 600 in the clockwise direction as shown in (e) of FIG. 3. Here, the rod 700 connected to the arm 600 and the hinge of the trunk door (now shown) pushes the hinge according to the rotation of the arm 600, thereby automatically opening the trunk door.

In various embodiments of the present invention, the process of automatically closing the trunk door is performed by the rotation and movement of the respective components which are made in a direction opposite to those of the above-described process of automatically opening the trunk door.

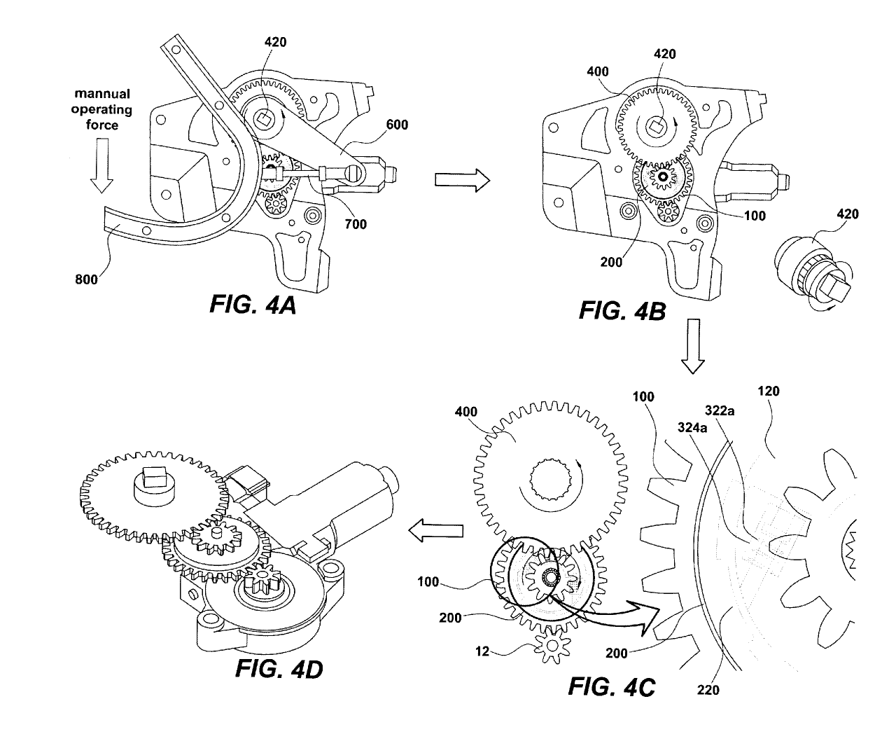

Meanwhile, FIG. 4 shows an operation in which the power trunk is manually opened and closed in accordance with various embodiments of the present invention. When the trunk door is closed, a hinge 800 of the trunk door rotates in the counterclockwise direction, and thus the rod 700 connected to the hinge 800 and the arm 600 transmits the rotational movement of the hinge 800 to the arm 600. As a result, the arm 600 rotates in the counterclockwise direction as shown in (a) of FIG. 4.

As the arm 600 rotates in the counterclockwise direction, the arm shaft 420 connected to the arm 600 and the main gear 400 rotates in the counterclockwise direction, and thus the arm shaft 420 transmits the rotational force of the arm 600 to the main gear 400, thereby rotating the main gear 400 in the counterclockwise direction as shown in (b) of FIG. 4.

As the main gear 400 rotates in the counterclockwise direction, the second middle gear 200 engaged with the main gear 400 rotates in the clockwise direction. Here, the stopper 300 located inside the second middle gear 200 does not receive the rotational force of the second middle gear 200, and thus the second middle gear 200 freely rotates as shown in (c) of FIG. 4.

That is, as the protruding portion 120 formed on the first middle gear 100 does not press any support formed on the stopper 300, the support does not project outside the stopper 300 and is not caught by the projection 220 formed inside the second middle gear 200. As a result, the second middle gear 200 does not rotate the stopper 300 and first middle gear 100, and thereby the rotational force is not transmitted to the motor 10.

In detail, only when the first middle gear 100 is rotated by the rotational force of the motor 10, the supports 320a and 320b of the stopper 300 according to the present invention are pressed by the protruding portion 120 formed on the first middle gear 100 and then project outside the stopper 300. When the second middle gear 200 is rotated by the manual opening and closing operation of the trunk door, the supports 320a and 320b do not project outside the stopper 300.

Therefore, during automatic opening and closing of the power trunk, the rotational force of the motor 10 can be transmitted to the hinge 800 of the trunk door through the first middle gear 100, the supports 320a and 320b of the stopper 300, and the second middle gear 200. However, during manual opening and closing of the power trunk, the rotational force of the hinge 800 of the trunk door is transmitted only to the second middle gear 200 and is not transmitted to the first middle gear 100 and the motor 10, thereby reducing the manual opening and closing force.

Meanwhile, the pinion gear 12 and the main gear 400 according to the present invention are configured to transmit the driving force of the motor 10 to the power trunk door at an appropriate gear ratio and it is apparent that they may be eliminated within the range not impairing the object of the present invention and can be easily modified by those skilled in the art.

According to various embodiments of the present invention, the drive module of the power trunk may be configured in such a manner that the motor rotates in a clockwise or counterclockwise direction according to the automatic opening and closing operation to open or close the trunk door and then rotates in a direction opposite to the rotational direction (in a counterclockwise or clockwise direction).

During the automatic opening and closing operation, the protruding portion 120 of the first middle gear 100 according to the present invention allows the supports 320a and 320b formed on the stopper 300 to project outside the stopper 300 and then is caught by the projection 220 of the second middle gear 200. Upon completion of the opening and closing operation, the motor 10 performs a predetermined rotation operation (preferably 1 rotation) in a direction opposite to the rotational direction for the opening and closing operation such that the supports 320a and 320b can be separated from the protruding portion 120.

Therefore, the protruding portion 120 does not press the supports 320a and 320b such that the supports 320a and 320b do not project outside the stopper 300 and are not caught by the projection 220 of the second middle gear 200. As a result, when the drunk door is manually opened and closed later, the second middle gear 200 can freely rotate without engagement with the first middle gear 100.

As described above, according to the drive module of the power trunk using the mechanical clutch gear of the present invention, the trunk door can be automatically opened and closed by the drive motor and, during manual opening and closing, the trunk door is not restricted by the drive motor, thereby reducing the manual opening and closing force, which allows a user to open and close the trunk door with a small force.

For convenience in explanation and accurate definition in the appended claims, the terms “inside” or “outside”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A drive module of a power trunk using a mechanical clutch gear, the drive module comprising:
a first middle gear receiving power of a motor and including a protruding portion formed on one side thereof;
a second middle gear including a plurality of projections formed on an inner circumference thereof; and
a stopper located inside the second middle gear,
wherein the stopper comprises two supports capable of being in contact with the protruding portion such that the protruding portion presses one of the two supports to project outside the stopper according to rotational movement of the first middle gear in a clockwise or counterclockwise direction and one end of the projecting support is caught by the projection of the second middle gear to transmit a rotational force of the first middle gear to the second middle gear.

2. The drive module of claim 1, wherein the two supports are configured to vertically penetrate both ends of the stopper, which are in contact with the protruding portion.

3. The drive module of claim 1, wherein each of the supports further comprises an elastic member such that, when the protruding portion presses the support in the rotational direction, one end of the support projects outside the stopper, whereas, when the protruding portion does not press the support, the one end of the support does not project outside the stopper by an elastic force of the elastic member.

4. The drive module of claim 1, wherein the protruding portion is formed into an arc shape.

5. The drive module of claim 1, further comprising:
an arm for transmitting and receiving a rotational force to and from the second middle gear; and
a rod connected to the arm and a door hinge of the power trunk to transmit and receive an opening and closing force of the power trunk.
